(19) United States
(12) Patent Application Publication
(10) Pub. No.: US 2015/0091553 A1
(43) Pub. Date: Apr. 2, 2015

(54) METHOD AND APPARATUS FOR A STUD FINDER

(71) Applicant: Hammond Wong, Fullerton, CA (US)

(72) Inventor: Hammond Wong, Fullerton, CA (US)

(21) Appl. No.: 14/039,417

(22) Filed: Sep. 27, 2013

(51) Int. Cl. G01V 3/165

(52) U.S. Cl. CPC G01V 3/165
USPC 324/207.11

(57) ABSTRACT

A stud finder including a magnetic device, a first housing in which the magnetic device is located, and a second housing having a flat surface, and fixed to the first housing. The magnetic device may be configured to move freely within the first housing when the magnetic device is not being held in an orientation and in a position with respect to the first housing by magnetic attraction to an object. The magnetic device may be configured to not move freely within the first housing when the magnetic device is being held in an orientation and in a position with respect to the first housing by magnetic attraction to an object. The magnetic device may have a top surface, and a peripheral surface, which may be at an angle with respect to the top surface. The top surface may have a substantially different appearance from the peripheral surface.

### FIELD OF THE INVENTION

This invention relates to improved methods and apparatus concerning stud finders.

### BACKGROUND OF THE INVENTION

In home construction nails are used to affix drywall on to studs or wooden framing or beams. The surface of the drywall is then covered with a joint compound and then sanded out. Joint compound, wall paper, and/or paint covers the surface of the drywall making it impossible to see where the studs, wood framing, or beams are, and also where the nails that affixed the drywall to the studs, wood framing, or beams are. Various devices are known in the art for locating the studs, in order to insert nails, fasteners, or screws into the studs, such as for hanging heavy paintings, anchoring heavy mirrors, fixing shelves to walls, and for other purposes. However these known “stud finder” devices have various deficiencies in accurately finding either the stud or the center of the stud.

### SUMMARY OF THE INVENTION

In at least one embodiment, an apparatus is provided which includes a magnetic device including a magnet, a first housing in which the magnetic device is located, and a second housing having a flat surface. The apparatus may be a stud finder for locating a stud, wood beam, or framing in a building. The first housing may be fixed to the second housing.

In at least one embodiment, the magnetic device is configured to move freely within the first housing when the magnetic device is not being held in an orientation and in a position with respect to the first housing by magnetic attraction to an object. In at least one embodiment, the magnetic device cannot move freely within the first housing when the magnetic device is being held in an orientation and in a position with respect to the first housing by magnetic attraction to an object.

The magnetic device may have a top surface, and a peripheral surface. The peripheral surface may be at an angle with respect to the top surface. The top surface of the magnetic device may have a substantially different appearance from the peripheral surface of the magnetic device. The magnetic device may include a magnetic housing which includes the peripheral surface, and which surrounds the magnet. The peripheral surface of the magnetic housing may be curved. The magnet may include the top surface, and the top surface may be substantially or entirely flat.

The apparatus may further include an electrical switch which is configured to be closed when the magnetic device is being held in an orientation and in a position with respect to the first housing by magnetic attraction to an object. The electrical switch may be configured to be open when the magnetic device is not being held in an orientation and in a position with respect to the first housing by magnetic attraction to an object.

The apparatus may further include a first laser device which is configured to be powered on and to emit a first laser beam when the electrical switch is closed. The apparatus may further include a second laser device which is configured to be powered on and to emit a second laser beam when the electrical switch is closed, the second laser beam emitted in a direction opposite that of the first laser beam. The second housing may have a length and a width, the length greater than the width. The first laser beam may be emitted in a first direction which is substantially parallel to the length of the second housing. The second laser beam may be emitted in a second direction which is substantially parallel to the length of the second housing, and which is opposite the first direction. The apparatus may further include a level indicator which is configured to indicate when the length of the second housing is substantially perpendicular to a ground surface.

The first housing may be a round outer covering having an inner substantially spherical chamber in which the magnetic device resides.

In at least one embodiment, a method is provided which includes placing a stud finder apparatus, comprised of a first housing and a second housing, on a building wall, such that a flat surface of the second housing of the stud finder apparatus is parallel and in contact with the building wall; and sliding the stud finder apparatus along the building wall, while the flat surface of the second housing of the stud finder apparatus is parallel and in contact with the building wall. The stud finder or apparatus may be configured as previously described.

The method may further include drawing a first line on a building wall which is aligned with a first laser beam emitted from a first laser device of the stud finder or apparatus. The method may further include drawing a second line on the building wall which is aligned with a second laser beam emitted from a second laser device of the stud finder or apparatus.

### BRIEF DESCRIPTION OF THE DRAWINGS

FIG. 1 shows a front, right, and top perspective view of a stud finder in accordance with an embodiment of the present invention;

FIG. 2 shows a top, and front perspective view of a magnet and a magnet housing for use with the stud finder of FIG. 1, along with magnetic lines of force, with the magnet shown inserted into the magnet housing;

FIG. 3A shows a top, and front perspective view of the magnet and magnet housing of FIG. 2, with the magnet and magnet housing shown separated from each other;

FIG. 3B shows a cross sectional view of the magnet and magnet housing with the magnet inserted into the magnet housing, along the line AA shown in FIG. 2;

FIG. 4 shows a cross sectional view of the stud finder of FIG. 1, along the line BB shown in FIG. 1, and without the magnet and the magnet housing shown in FIG. 2;

FIG. 5 shows a top, right, and rear perspective view of a first portion of the stud finder of FIG. 1;

FIG. 6A shows a sectional view of a stud, a drywall, a nail, and the stud finder of FIG. 1, with the stud finder shown at a first position with respect to the nail;

FIG. 6B shows a sectional view of the stud, the drywall, the nail, and the stud finder of FIG. 1, with the stud finder shown at a second position with respect to the nail;

FIG. 6C shows a sectional view of the stud, the drywall, the nail, and the stud finder of FIG. 1, with the stud finder shown at the second position with respect to the nail, and with two laser beams, and two pencils shown;

FIG. 7 shows a block diagram 300 of an electrical circuit including various components of an embodiment of the present invention;

FIG. 8A shows a top view of the stud finder of FIG. 1, placed over the drywall and the stud, of FIGS. 6A, 6B, and 6C, with the stud finder in a location such that the magnet of FIG. 2 is not over the nail of FIGS. 6A-6C;

FIG. 8B shows a top view of the stud finder of FIG. 1, placed over the drywall and the stud, of FIGS. 6A, 6B, and 6C, with the stud finder in a location such that the magnet of FIG. 2 is over the nail of FIGS. 6A-6C; and

FIG. 8C shows a top view of the stud finder of FIG. 1, placed over the drywall and the stud, of FIGS. 6A, 6B, and 6C, with the stud finder in a location such that the magnet of FIG. 2 is over the nail of FIGS. 6A-6C, and one or more pencils are used to mark the location along the two laser beams.

### DETAILED DESCRIPTION OF THE DRAWINGS

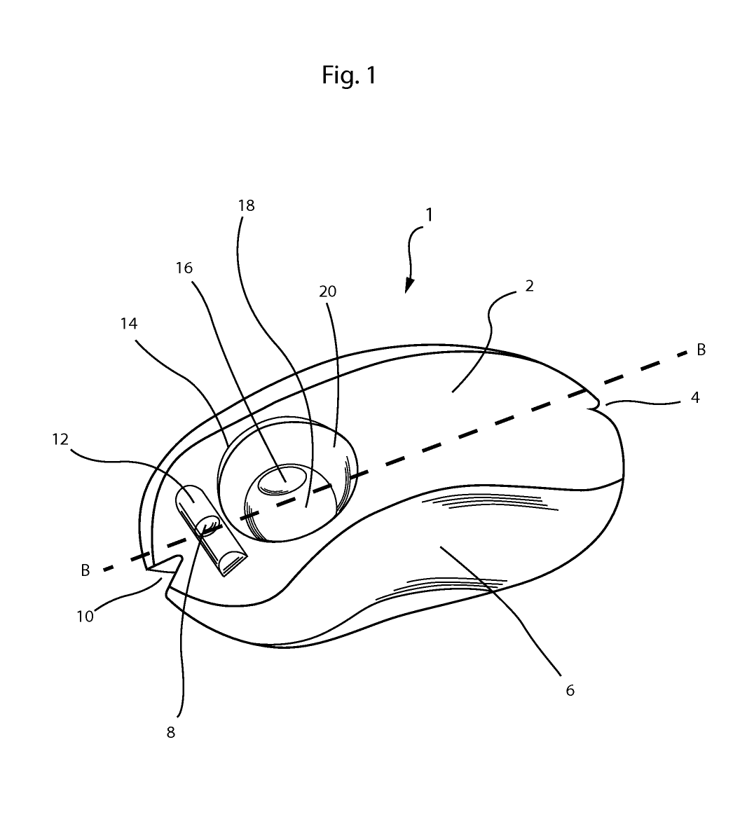

FIG. 1 shows a front, right, and top perspective view of a stud finder 1 in accordance with an embodiment of the present invention. The stud finder 1 includes a housing 2, a marking place 4, a grip 6, a ball indicator 8, a marking place 10, a level 12, a housing 14, a magnet 16, a magnet housing 18, and a housing 20. In at least one embodiment it is critical that the housing 14 be transparent so that the magnet 16 can be seen. Housing 14 may typically be a clear plastic housing.

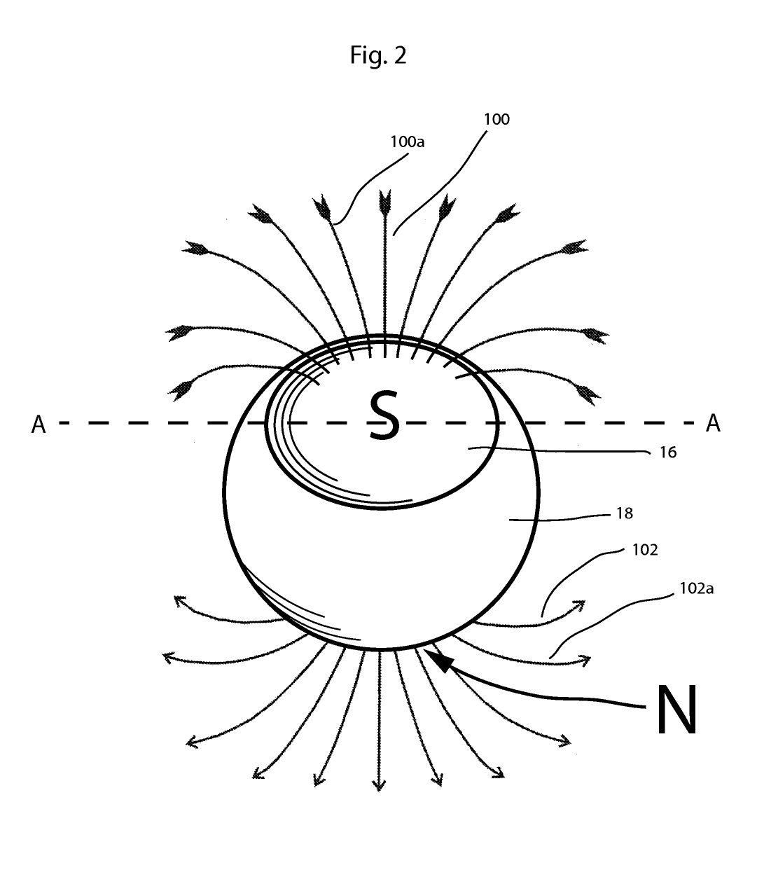

FIG. 2 shows a top, and front perspective view of the magnet 16 and the magnet housing 18 for use with the stud finder 1, along with magnetic lines of force 100 and 102. The magnetic lines of force 100, such as magnetic line of force 100a, may be described as emanating from a south pole S of a magnetic field. The magnetic lines of force 102, such as magnetic line of force 102a, may be described as emanating from a north pole N of a magnetic field. A line AA is shown in FIG. 2. In FIG. 2, the magnet 16 is shown inserted into the magnet housing 18.

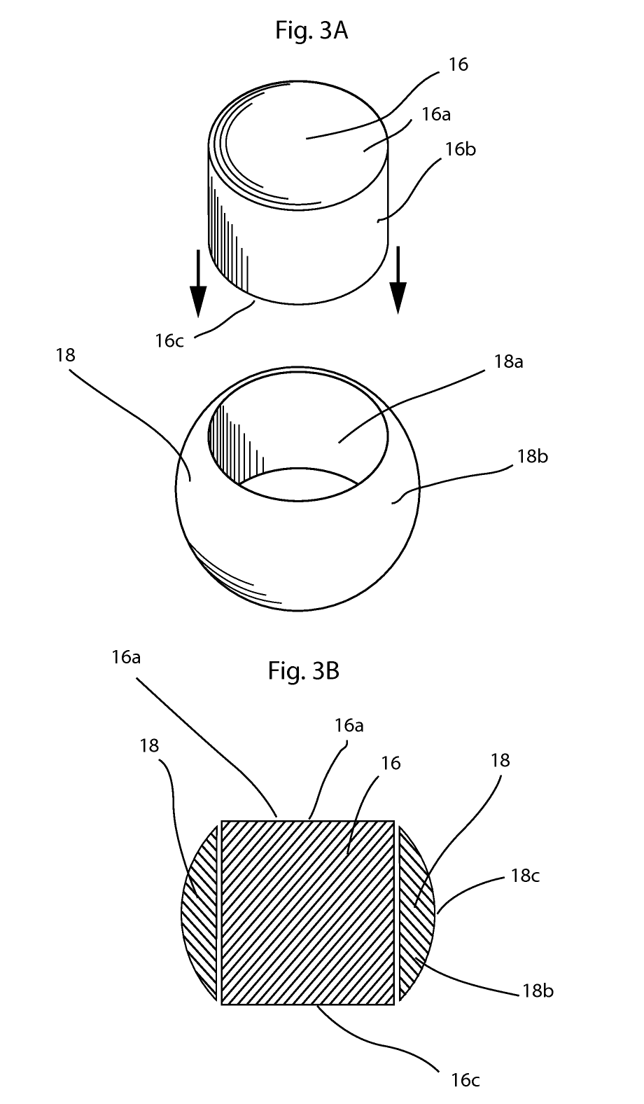

FIG. 3A shows a top, and front perspective view of the magnet 16 and magnet housing 18 of FIG. 2, with the magnet 16 and the magnet housing 18 shown separated from each other. The magnet 16 has a top surface 16a, a side or peripheral surface 16b, and a bottom surface 16c. The magnet housing 18 has an inner chamber 18a and a peripheral wall 18b. The peripheral wall 18b has a curved outer surface 18c shown in FIG. 3B.

FIG. 3B shows a cross sectional view of the magnet 16 and magnet housing 18 with the magnet 16 inserted into the magnet housing 18, along the line AA shown in FIG. 2. In at least one embodiment, the top surface 16a of the magnet 16 has a color such as red. The top surface 16a may be painted in a color red. In at least one embodiment, the bottom surface 16c of the magnet 16 has a color such as red. The bottom surface 16c may be painted in a color red.

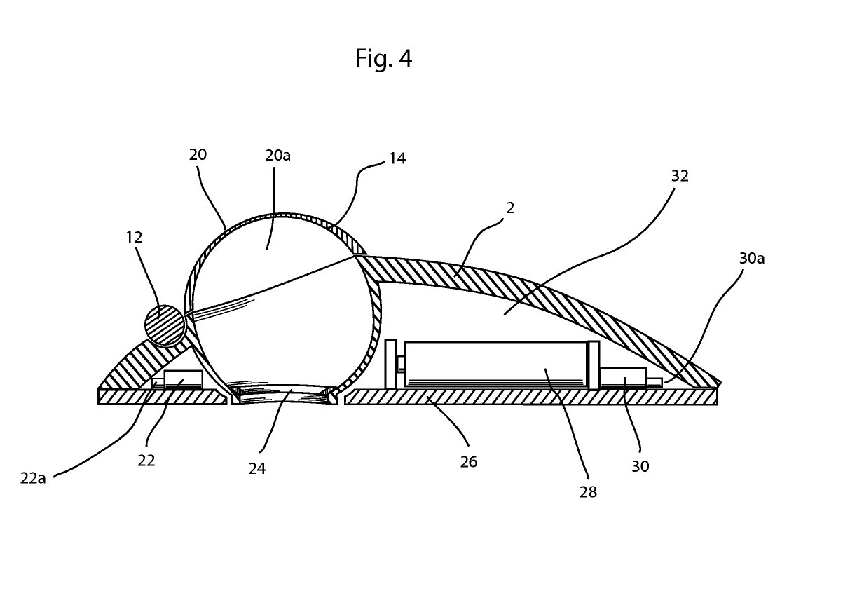

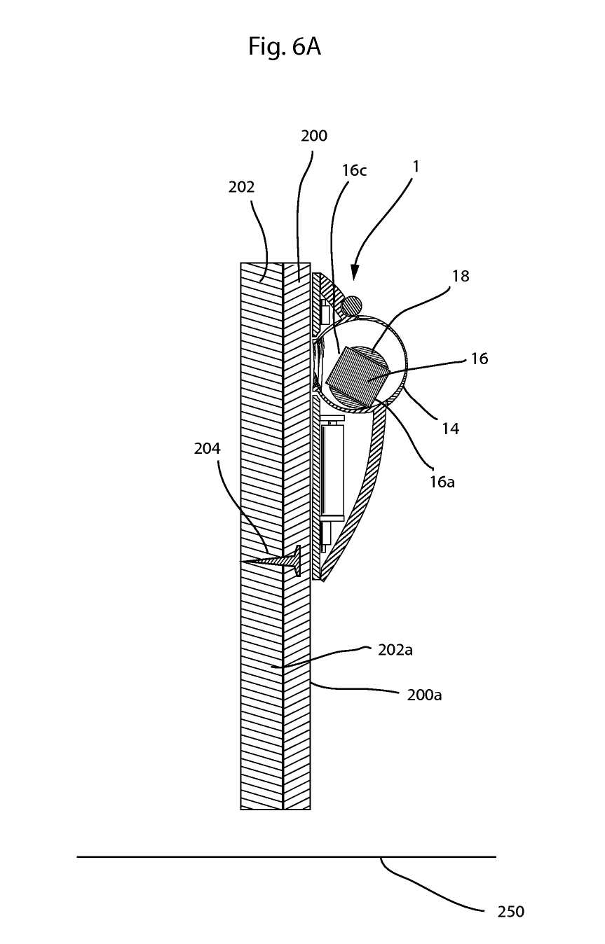

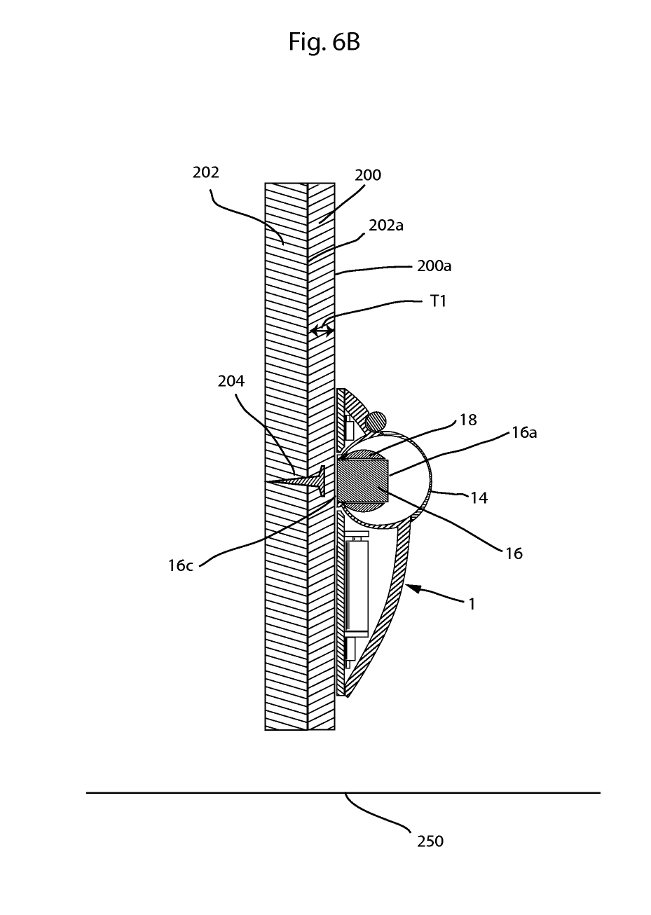

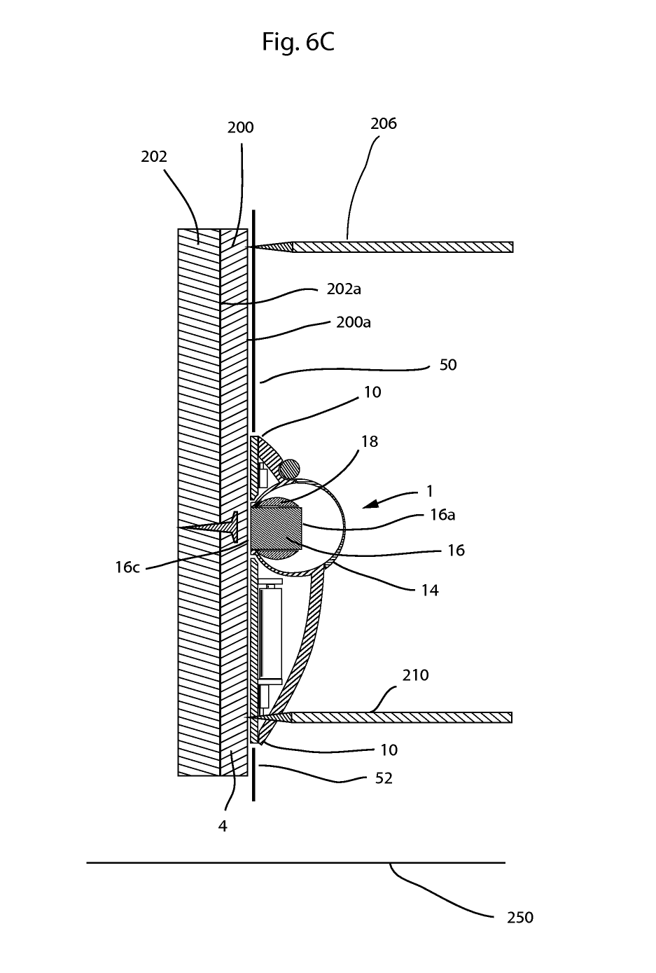

FIG. 4 shows a cross sectional view of the stud finder 1 of FIG. 1, along the line BB shown in FIG. 1, and without the magnet 16 and the magnet housing 18 shown in FIG. 2. As shown by FIG. 4, the stud finder 1 includes the level 12, a chamber or space 20a of the housing 20 for the magnet 16 and housing 18, a laser device 22, a pressure sensitive on/off switch 24, a base cap 26, a battery 28, a laser device 30, a chamber 32, and housing or body 2. The chamber or space 20a is large enough to allow the combination of the magnet 16 and the magnet housing 18 to move freely in the chamber 20a, except when the magnet 16 is attracted to an object, such as nail 204, as shown in FIG. 6B. If the stud finder or apparatus 1 is placed in an orientation perpendicular to ground or ground surface 250 as shown in FIG. 6A-6B, the combination of the magnet 16 and the housing 18 will orient itself as shown in FIG. 6A when there is no object attracting the magnet 16 due to the weight, center of mass, and other characteristics of the combination of the magnet 16 and 18. In the configuration of FIG. 6A, the surface 16a, having the color red for example, cannot be seen or cannot be clearly seen. However, if the stud finder 1 is placed in an orientation perpendicular to ground 250 and the magnet is attracted to the nail 204 as shown in FIG. 6B, the combination of the magnet 16 and the housing 18 will orient itself as shown in FIG. 6B, so that the surface 16a can be clearly seen through the housing 14. The combination of the magnetic characteristics of magnet 16, the flat surface 16c, and the curved surface 18c of the housing 18, aid in causing the combination of the magnet 16 and the housing 18 to align or orient itself as shown in FIG. 6B, when the magnet 16 is attracted to an object, such as nail 204.

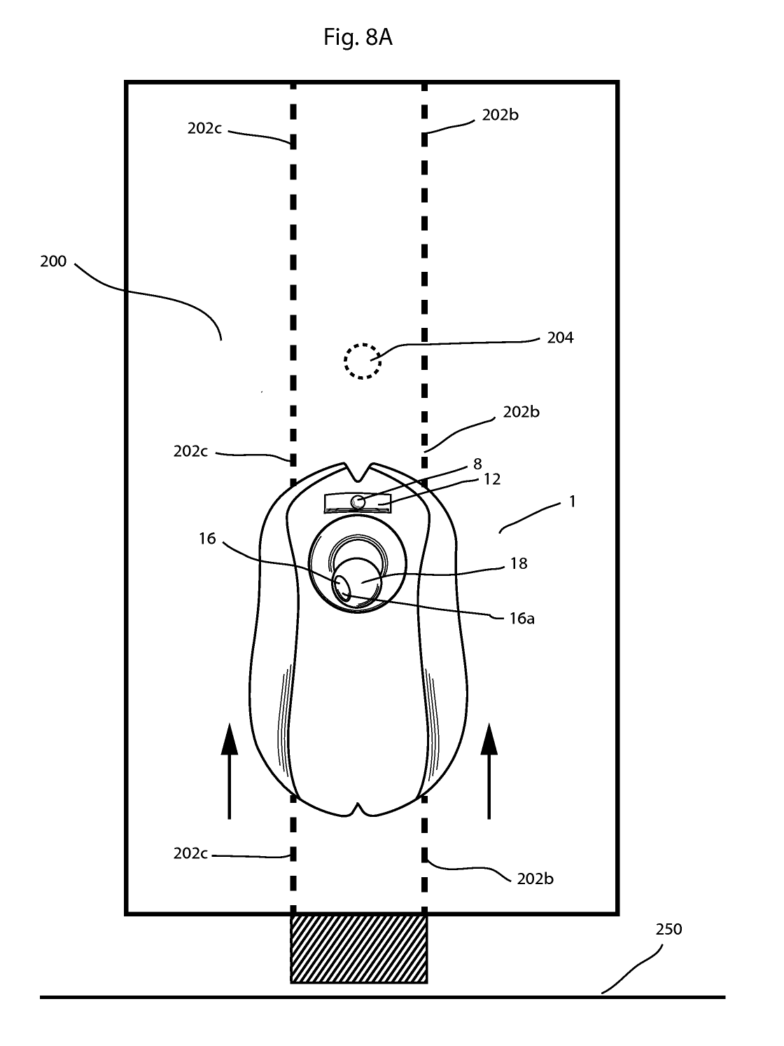

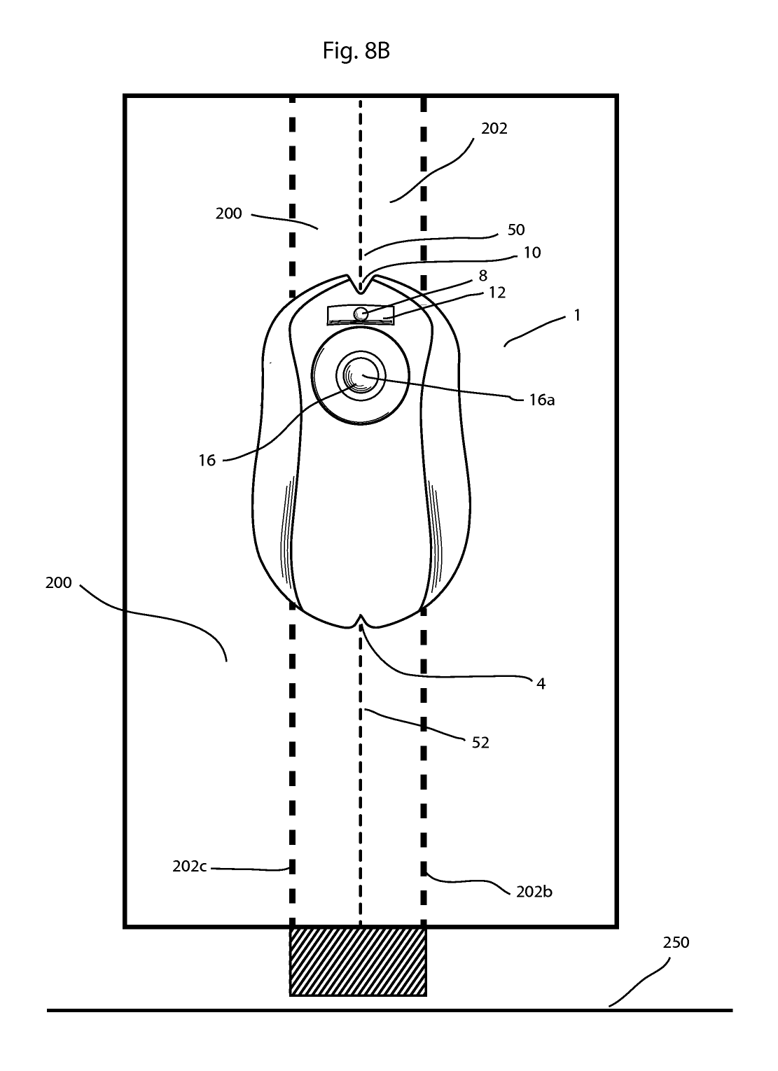

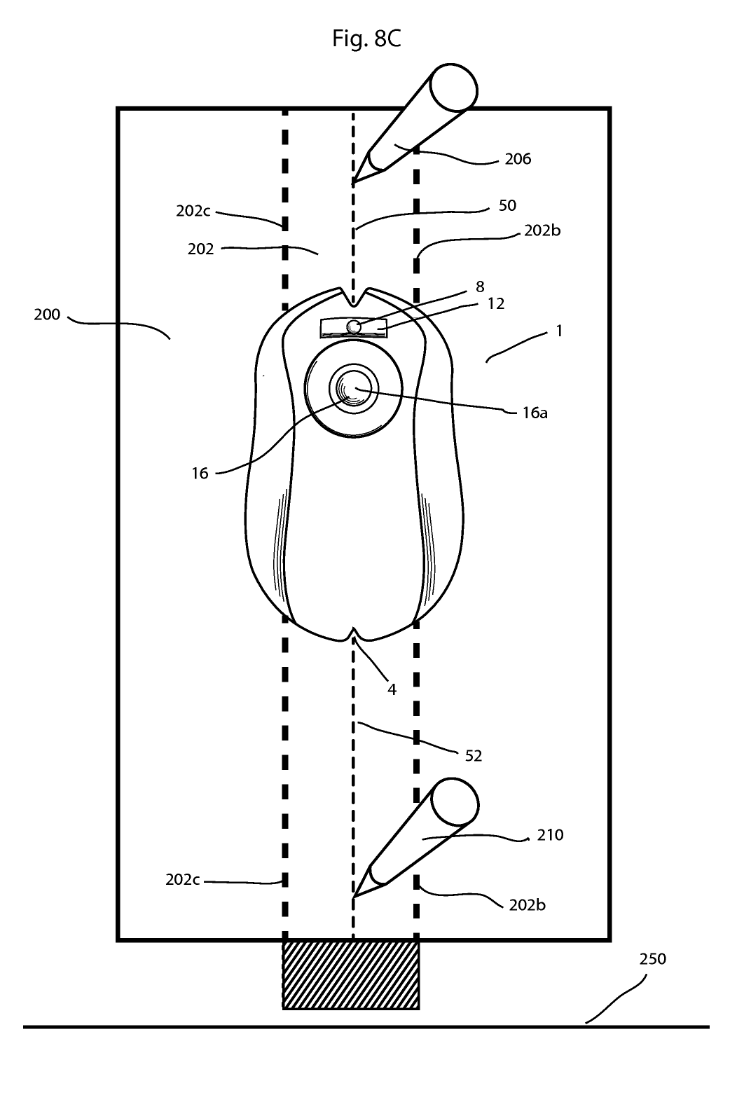

Laser devices 22 and 30 may include portions 22a and 30a, respectively, through each of which a laser beam is emitted when the laser devices 22 and 30, respectively, have power supplied to them by battery 28. In at least one embodiment, the magnet 16 falls into a space where switch 24 is embedded, when the magnet 16 is in the position of FIG. 8B over the nail 204, and this triggers the switch 24 to on or closed in order to power the laser devices 22 and 30 by battery 28.

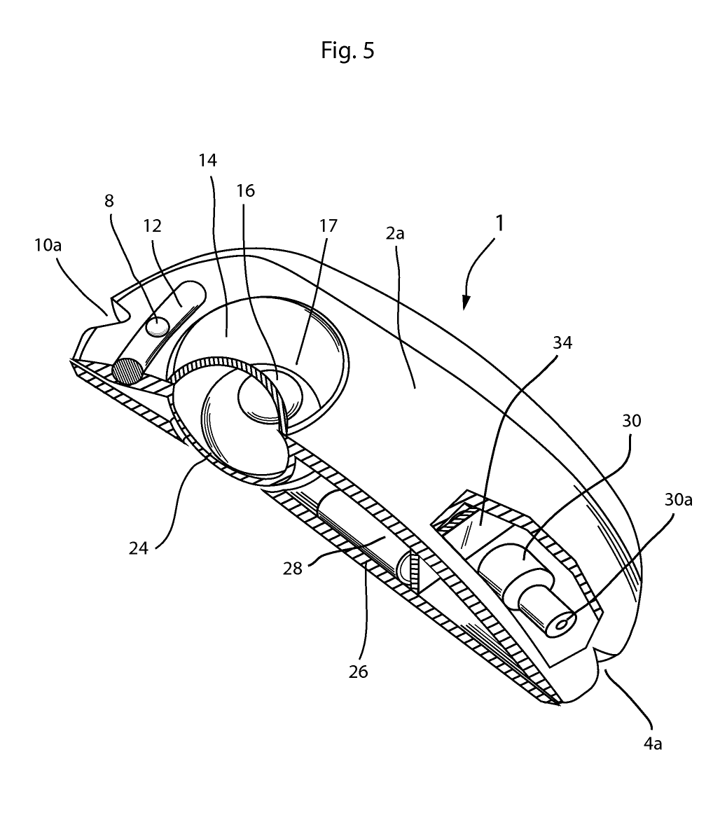

FIG. 5 shows a top, right, and rear perspective view of a first portion of the stud finder 1. In FIG. 5, a second portion of the stud finder 1, has been cut off along the line BB shown in FIG. 1. FIG. 5 shows a marking 4a and a marking 10a which are used to make it easier to mark, such as with a pencil, a location centrally on drywall after a stud is found. FIG. 5 also shows a nail finder 17 which may include magnet 16, a top cap 2a, a connection wall 34, a laser device 30 and laser device portion 30a, a battery 28, a base cap 26, and a pressure sensitive on/off switch 24.

FIG. 6A shows a sectional view of a stud 202 (such as a two inch by four inch piece of wood, used in home construction), a drywall 200, a nail 204, and the stud finder 1, with the stud finder 1 shown at a first position with respect to the nail 204. In the position of FIG. 6A the stud finder 1 has not found a nail. FIG. 6A also shows the magnet 16 and the magnet housing 18 within the clear plastic cap or bubble 14. In FIG. 6A, the surfaces 16c and 16a of the magnet 16 are not clearly shown from the top of the cap or bubble 14. The surfaces 16c and 16a of the magnet 16 are not substantially parallel to the surface 200a of the drywall 200 and the surface 202a of the stud 202.

FIG. 6B shows a sectional view of the stud 202, the drywall 200, the nail 204, and the stud finder 1 of FIG. 1, with the stud finder 1 shown at a second position with respect to the nail 202. In FIG. 6B, the stud finder 1 has found the stud 202 by locating the nail 204 which is driven into the stud 202. In FIG. 6B, the surfaces 16c and 16a of the magnet 16 are now substantially parallel with the surface 200a and the surface 202a of the drywall 200 and the stud 202, respectively. This is because the magnet 16 is attracted to the nail 204. In the configuration of 6B, the surface 16a can be seen clearly through the top of the transparent cap or bubble 14. The surface 16a and the surface 16c are typically colored a color different from the peripheral surface 16b. For example surfaces 16a and 16c may be red, while surface 16b may be white. Thus, when the color of surface 16a is completely visible, because the magnet 16 has snapped into the position of FIG. 6B, it means that a stud, such as stud 202 has been found by finding a nail, such as nail 204.

FIG. 6C shows a sectional view of the stud 202, the drywall 200, the nail 204, and the stud finder 1 of FIG. 1, with the stud finder 1 shown at the second position with respect to the nail 204, and with a laser beam 50 and a laser beam 52, and two pencils 206, and 210, shown. In FIG. 6C, the laser beams 50 and 52 which may emanate from the lasers or laser devices 22 and 30, respectively, shown in FIG. 4, may be used to mark a line where a stud appears to be located, after locating nail 204. The pencil 210 may mark the line formed by laser beam 52 through the marking 4 shown in FIG. 1, and the pencil 206 may mark the line formed by laser beam 50 through the marking 10 shown in FIG. 1.

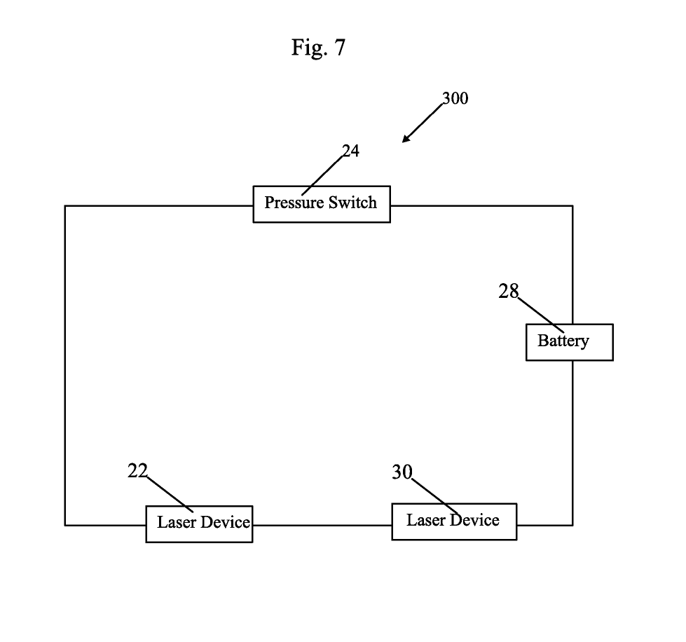

In operation, the magnet 16 is attracted to nail 204, and becomes oriented as shown in FIG. 6B, when the magnetic 16 is closely adjacent to the nail 204. In the orientation of FIG. 6B, pressure of the surface 16c of the magnet 16 shown in FIG. 3B on the pressure sensitive switch 24, shown in FIG. 4 causes a circuit to be completed, for the circuit shown by FIG. 7, wherein the circuit includes the battery 28, and the laser devices 22 and 30 shown in FIG. 4, so that the laser devices 22 and 30 are turned on, emitting laser beams 50 and 52, respectively, shown in FIG. 6C.

FIG. 7 shows a block diagram 300 of an electrical circuit including various components of an embodiment of the present invention. The block diagram includes pressure switch 24, laser devices 22 and 30, and the battery 28. In operation, the magnet 16 when in the orientation shown in FIG. 6B, applies pressure to the pressure switch 24 causing the pressure switch 24 to close, which causes the components 24, 28, 22, and 30 to be in a closed circuit. In this closed circuit the battery 28 supplies power to the laser devices 22 and 30, turning on the laser beams 50 and 52, respectively, as shown in FIG. 6C. When the magnet 16 is in the orientations shown in FIG. 6A, the magnet does not apply pressure to the pressure switch 24, and the pressure switch 24 is open which causes the circuit shown in FIG. 7 to be an open circuit, such that the battery 28 does not supply power to the laser devices 22 and 30, and the laser beams 50 and 52 are off.

FIG. 8A shows a top view of the stud finder 1 placed over the drywall 200 and the stud (such as a two by four inch piece of wood or wood plank used in construction) 202, of FIGS. 6A, 6B, and 6C, with the stud finder 1 in a location such that the magnet 16 of FIG. 2 is not over the nail 204 of FIGS. 6A-6C. In FIG. 8A, the location of the stud 202 is shown by dashed lines 202b and 202c. However, the stud 202 cannot be seen from the view of FIG. 8A, because the stud 202 is behind the drywall 200. In addition the location of the nail 204 is shown by a dashed line circle 204 but the nail 204 is behind drywall 200 and cannot be seen in the view of FIG. 8A. In FIG. 8A, because the magnet 16 is not over the nail 204, the magnet surface 16a, is off to the side and cannot be seen clearly in FIG. 8A.

FIG. 8B shows a top view of the stud finder 1, placed over the drywall 200 and the stud 202, of FIGS. 6A, 6B, and 6C, with the stud finder 1 in a location such that the magnet 16 of FIG. 2 is over the nail 204 of FIGS. 6A-6C. In FIG. 8B, the surface 16a of the magnet 16 can be clearly seen because the magnet surface 16c, shown in FIG. 3B, is attracted to the nail 204, making the magnet 16 stand upright in FIG. 8B.

FIG. 8C shows a top view of the stud finder 1 of FIG. 1, placed over the drywall 200 and the stud 202, of FIGS. 6A, 6B, and 6C, with the stud finder 1 in a location such that the magnet 16 of FIG. 2 is over the nail 204 of FIGS. 6A-6C, and one or more pencils, such as pencils 206 and 210 are used to mark the location along the two laser beams. The pencil 206 may be used to mark the location of laser beam 50 and the pencil 210 may be used to mark the location of laser beam 52. The laser beams 50 and 52 are aligned with each other and when joined by a straight line make a straight line which identifies where the stud 202 is. Typically the nail 204 will be approximately in the center of the stud 202, so that the laser beams 50 and 52, and a line joining and coinciding with the laser beams 50 and 52, identifies approximately the center of the beam or stud 202.

As shown in FIGS. 1, 8A, 8B, and 8C, the stud finder 1 includes a level 12, inside of which is a ball indicator 8. The level 12 may be any type of level indicator. For example the level 12 may be a ball in water level indicator, having a ball or ball indicator 8. In operation, when the level 12 is parallel to a ground surface 250, show in FIGS. 8A-8C, the ball 8 will be in the center or substantially in the center of the level 12, as shown in FIGS. 8A-8C. In this configuration a line connecting and overlapping laser beams 50 and 52 in FIG. 8C, will be parallel to the stud or wood beam 202, will lie within the ends or sides of the stud 202 delineated by lines 202b and 202c, and will be substantially central within the lines 202b and 202c, assuming the nail 204 is substantially central with respect to the lines 202b and 202c. In at least one embodiment, the use of level 12 is critical, because without the level 12 joining and overlapping the lines formed by laser beams 50 and 52 may result in a line which goes outside of the stud 202.

In operation, in the configuration of FIG. 8C, with the ball indicator 8 centrally located in the level 12, an individual would draw a line with pencils 206 and/or 210, which joins and overlaps the lines formed by laser beams 50 and 52. After the line is drawn by pencils 206 and/or 210, the individual may hammer a nail or drive a screw through the line formed by the pencils 206 and/or 210, through the drywall 200, and into the stud 202. The nail or screw driven into the stud 202 through the line formed by laser beams 50 and 52, may be used, for example, to hang up a heavy mirror or painting, or to anchor a shelf or cabinet to a wall.

Since the line drawn is within lines 202b and 202c, any nail or screw inserted through the drawn line, perpendicular to the drywall 200 as in FIG. 6B, having a length greater than the drywall 200 thickness T1 shown in FIG. 6B, will be driven into the stud 202. Thus, the stud finder 1 not only allows an individual to find the stud 202, by finding nail 204, but also allows the individual to draw a line on the drywall 200, which identifies the location of the stud 202, and preferably the center of the stud 202, along the drawn line.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a magnetic device including a magnet;
a first housing in which the magnetic device is located;
a second housing having a flat surface;
wherein the first housing is fixed to the second housing;
wherein the magnetic device can move freely within the first housing when the magnetic device is not being held in an orientation and in a position with respect to the first housing by magnetic attraction to an object;
wherein the magnetic device cannot move freely within the first housing when the magnetic device is being held in an orientation and in a position with respect to the first housing by magnetic attraction to an object;
wherein the magnetic device has a top surface, and a peripheral surface, the peripheral surface at an angle with respect to the top surface;
and wherein the top surface of the magnetic device has a substantially different appearance from the peripheral surface of the magnetic device.

2. The apparatus of claim 1 wherein
the magnetic device includes a magnetic housing which includes the peripheral surface, and which surrounds the magnet;
and wherein the peripheral surface of the magnetic housing is curved.

3. The apparatus of claim 1 wherein
the magnet includes the top surface, and the top surface is substantially flat.

4. The apparatus of claim 1 further comprising
a electrical switch which is configured to be closed when the magnetic device is being held in an orientation and in a position with respect to the first housing by magnetic attraction to an object;
and wherein the electrical switch is configured to be open when the magnetic device is not being held in an orientation and in a position with respect to the first housing by magnetic attraction to an object.

5. The apparatus of claim 4 further comprising
a first laser device which is configured to be powered on and to emit a first laser beam when the electrical switch is closed.

6. The apparatus of claim 5 further comprising
a second laser device which is configured to be powered on and to emit a second laser beam when the electrical switch is closed, the second laser beam emitted in a direction opposite that of the first laser beam.

7. The apparatus of claim 5 wherein
the second housing has a length and a width, the length greater than the width; and
wherein the first laser beam is emitted in a first direction which is substantially parallel to the length of the second housing.

8. The apparatus of claim 6 wherein
the second housing has a length and a width, the length greater than the width; and
wherein the first laser beam is emitted in a first direction which is substantially parallel to the length of the second housing; and
wherein the second laser beam is emitted in a second direction which is substantially parallel to the length of the second housing, and which is opposite the first direction.

9. The apparatus of claim 1 wherein
the second housing has a length and a width, the length greater than the width; and
further comprising a level indicator which is configured to indicate when the length of the second housing is substantially perpendicular to a ground surface.

10. The apparatus of claim 1 wherein
the first housing is a round outer covering having an inner substantially spherical chamber in which the magnetic device resides.

11. A method comprising:
placing a stud finder apparatus, comprised of a first housing and a second housing, on a building wall, such that a flat surface of the second housing of the stud finder apparatus is parallel and in contract with the building wall;
sliding the stud finder apparatus along the building wall, while the flat surface of the second housing of the stud finder apparatus is parallel and in contract with the building wall;
wherein the stud finder apparatus is comprised of:
a magnetic device including a magnet;
the first housing in which the magnetic device is located;
the second housing having the flat surface;
wherein the first housing is fixed to the second housing;
wherein the magnetic device can move freely within the first housing when the magnetic device is not being held in an orientation and in a position with respect to the first housing by magnetic attraction to an object;
wherein the magnetic device can not move freely within the first housing when the magnetic device is being held in an orientation and in a position with respect to the first housing by magnetic attraction to an object;
wherein the magnetic device has a top surface, and a peripheral surface, the peripheral surface at an angle with respect to the top surface;
and wherein the top surface of the magnetic device has a substantially different appearance from the peripheral surface of the magnetic device.

12. The method of claim 11 wherein
the magnetic device includes a magnetic housing which includes the peripheral surface, and which surrounds the magnet;
and wherein the peripheral surface of the magnetic housing is curved.

13. The method of claim 11 wherein
the magnet includes the top surface, and the top surface is substantially flat.

14. The method of claim 11 wherein
the stud finder apparatus includes a electrical switch which is configured to be closed when the magnetic device is being held in an orientation and in a position with respect to the first housing by magnetic attraction to an object;
and wherein the electrical switch is configured to be open when the magnetic device is not being held in an orientation and in a position with respect to the first housing by magnetic attraction to an object.

15. The method of claim 14 wherein
the stud finder apparatus includes a first laser device which is configured to be powered on and to emit a first laser beam when the electrical switch is closed;
and further comprising drawing a first line on the building wall which is aligned with the first laser beam.

16. The method of claim 15 wherein
the stud finder apparatus includes a second laser device which is configured to be powered on and to emit a second laser beam when the electrical switch is closed, the second laser beam emitted in a direction opposite that of the first laser beam;
and further comprising drawing a second line on the building wall which is aligned with the second laser beam.

17. The method of claim 15 wherein
the second housing has a length and a width, the length greater than the width; and
wherein the first laser beam is emitted in a first direction which is substantially parallel to the length of the second housing.

18. The method of claim 16 wherein
the second housing has a length and a width, the length greater than the width; and
wherein the first laser beam is emitted in a first direction which is substantially parallel to the length of the second housing; and
wherein the second laser beam is emitted in a second direction which is substantially parallel to the length of the second housing, and which is opposite the first direction.

19. The method of claim 11 wherein
the second housing has a length and a width, the length greater than the width; and
and wherein the stud finder further includes a level indicator which is configured to indicate when the length of the second housing is substantially perpendicular to a ground surface.

20. The method of claim 11 wherein
the first housing is a round outer covering having an inner spherical chamber in which the magnetic device resides.
